(19) United States
(12) Patent Application Publication
(10) Pub. No.: US 2026/0257355 A1
(43) Pub. Date: Sep. 3, 2026

(54) METHOD AND SYSTEM FOR OPERATING A ROBOT

(71) Applicant: KUKA Deutschland GmbH, Augsburg (DE)

(72) Inventor: Andreas Keibel, Augsburg (DE)

(73) Assignee: KUKA Deutschland GmbH, Augsburg (DE)

(21) Appl. No.: 18/875,425

(22) PCT Filed: Jun. 9, 2023
(86) PCT No.: PCT/EP2023/065460

§ 371 Date: Dec. 16, 2024

(30) Foreign Application Priority Data
Jun. 23, 2022 (DE) 10 2022 206 320.1

(51) Int. Cl. B25J 9/16; B25J 9/02

(52) U.S. Cl. CPC B25J 9/1638; B25J 9/023

(57) ABSTRACT

To operate a robot having a plurality of joints, during a movement of the robot effected by joint drives, for two or more, in particular all, joints, in each case based on at least one sensor value, a current one-dimensional or multi-dimensional load variable value for the corresponding joint is determined and, based on this current load variable value and a one-dimensional or multi-dimensional predetermined limit value for the joint, a one-dimensional or multi-dimensional load value for the joint is determined, wherein, based on the load values, an action of the robot is carried out to reduce one or more components of these load values and/or, based on the load values, a load situation of the robot is signaled and/or stored.

### CROSS-REFERENCE TO RELATED APPLICATIONS

This application is a national phase application under 35 U.S.C. § 371 of International Patent Application No. PCT/EP2023/065460, filed Jun. 9, 2023 (pending), which claims the benefit of priority to German Patent Application No. DE 10 2022 206 320.1, filed Jun. 23, 2022, the disclosures of which are incorporated by reference herein in their entirety.

### TECHNICAL FIELD

The present invention relates to a method and system for operating a robot, and to a computer program or computer program product for carrying out the method.

### BACKGROUND

Robots comprise various components, such as kinematic structural bodies, drive motors, gears, brakes, bearings, sensors, and the like, each of which has different load limits with regard to different loads and is also loaded differently depending on the current pose and movement of the robot.

Up to now, this has only been taken into account very roughly by maximum permissible loads, which are defined for the most unfavorable poses, for example outstretched or cantilevered robot arms.

### SUMMARY

The object of the present invention is to improve the operation of a robot.

This object is achieved by a method, a system, or a computer program or computer program product for carrying out a method as described herein.

According to one embodiment of the present invention, a robot, which in a development has a robot arm, and in one embodiment is a robot arm, comprises multiple, preferably at least three, in one embodiment at least six, in a development at least seven, joints, in one embodiment rotary joints, which are adjustable or are adjusted by joint drives, preferably electromotive ones, in order to cause a movement of the robot.

According to one embodiment of the present invention, during a movement of the robot caused by its joint drives, for two or more joints, preferably all joints:
based on a (measured) value from at least one sensor, and in one embodiment on (measured) values from multiple sensors, a current one-dimensional or multi-dimensional load variable value is determined for the corresponding joint, or specifically for the joint; and
based on this current load variable value and a one-dimensional or multi-dimensional predetermined limit value for the corresponding joint, in one embodiment based on a difference between the limit value and the load variable value for the joint, a one-dimensional or multi-dimensional load value is determined for the joint, or specifically for the joint.

In the case of multidimensional load variable values, limit values, and load values, components or dimensions of the load variable values, limit values, and load values are assigned to one another in one embodiment, preferably in such a way that the component j of the load value for the joint i is determined based on the corresponding dimension or component j of the load variable value for the joint i and the corresponding dimension or component j of the limit value for the joint i, or, in general form:

$$B ( i , j ) = B ( L ( i , j ) , G ( i , j ) ) , i = 1 , … number of joints ; \\ j = 1 , … dimension or number of components of load variable values , \\ limit value , and load values$$

Where
B(i,j): component j of the load value for the joint i;
L(i,j): component j of the load variable value for the joint i;
G(i,j): component j of the limit value for the joint i;

By using multiple components, in one embodiment different loads can be taken into account, for example both torques and speeds, or the like.

In one embodiment, the limit value is predetermined (in each case) on the basis of permissible loads of one or more components, in particular at least one kinematic structural body, drive motor, bearing, sensor, transmission, and/or at least one brake, of the robot.

One embodiment of the present invention is based on the idea of specifying joint-specific or axle-specific limit values for different components based on permissible loads, and comparing current values with these. In this way, it is possible to determine in which joints or axes the loads are currently far from their permissible maximum values, and to react to this in an advantageous manner in order to influence the operation of the robot, preferably to avoid unwanted overloading.

The load variable value and/or load value for a joint depends, in one embodiment, (in each case) on a torque at the (corresponding) joint; in particular, a component of the load value can indicate such a torque. This allows mechanical loads to be advantageously taken into account in one embodiment.

Additionally or alternatively, in one embodiment the load variable value and/or load value for a joint depends (in each case) on a speed at the (corresponding) joint; in particular, a component of the load value can indicate such a speed. This allows dynamic loads to be advantageously taken into account in one embodiment.

In a development, the load variable value and/or load value for a joint depends (in each case) on both a torque and a speed at the (corresponding) joint. In one embodiment, the load variable value and/or load value, in particular a component of the load variable value or load value, can depend on a product of torque and (rotational) speed, in particular a power level, and can in particular indicate this. This allows a degree of wear to be taken into account particularly advantageously in one embodiment.

In one embodiment, as stated above, the multi-dimensional load value can comprise a component that depends on a torque at the (corresponding) joint, in particular indicating this, and/or a component that depends on a speed at the (corresponding) joint, in particular indicating this, and/or a component that depends on a product of torque at the (corresponding) joint and speed at the (corresponding) joint, in particular indicating this. This makes it possible to advantageously take different loads into account together.

In one embodiment, a torque or a speed at a joint comprises a torque or a speed between two members of the joint that can be rotated relative to one another, in particular a torque or a speed of a joint drive, in particular a motor and/or transmission, of the joint, and/or between two structural members of the joint that can be rotated relative to one another.

In one embodiment, at least one component of the load variable values for the joints is measured by the corresponding sensors, for example torques by torque sensors and/or (rotational) speeds by (rotational) speed sensors, wherein in a development the measured values are further processed, for example by filtering, averaging, smoothing, scaling, or the like. This means that the load variable values or load values can be determined (more) precisely in one embodiment.

In one embodiment, at least one component of the load variable values for the joints is determined on the basis of a mathematical model or observer, for example torques using a model or observer based on measured positions, speeds, temperatures, currents and/or voltages of drive motors or the like. This makes it possible, in one embodiment, to advantageously use existing sensors and/or to take into account load variable values, or load values, that cannot be measured directly.

Based on the determined load values, according to one embodiment of the present invention, an action of the robot is carried out to reduce one or more components of the load values, or with the proviso or in such a way that (by this action) this component(s) is reduced.

One embodiment of the present invention is therefore based on the idea of carrying out different actions depending on how far the loads in the individual joints of the robot are from their permissible limit values in each case, and thereby preferably avoiding unwanted overloading of the robot as far as possible. In this way, in one embodiment the robot can be brought closer to its permissible joint-specific and component-specific load limits, thereby improving its operation.

In addition or as an alternative to this aspect of reducing load values by an action of the robot which is determined or predetermined based on the load values, according to one embodiment of the present invention, a load situation of the robot is signaled based on the load values, in one embodiment optically and/or acoustically, to an operator who in one embodiment cooperates with the robot, and/or is signaled via data to an application program which, in a development, in response to this causes the robot to carry out an application-program-specific (predetermined) action, in one embodiment an action in which load values temporarily exceed predetermined limit values.

This allows a user to react in an application-specific and therefore particularly advantageous manner when loads in individual joints approach or exceed predetermined limit values, for example by allowing the user or an application program to exceed these limits, at least for a short time, or by accepting a corresponding brief overloading of the robot in order to achieve a higher-ranking goal of the application program, by switching the robot to a flexible mode in order to avoid overloading caused by joint drives working against the environment, or by taking other actions.

In addition or as an alternative to this aspect of signaling a load situation of the robot, and in addition or as an alternative to the aforementioned aspect of reducing load values by an action of the robot that is determined or predetermined based on the load values, according to one embodiment of the present invention a load situation of the robot is stored based on the load values and, in a development, the stored load situation of the robot is used for an analysis, in particular damage and/or wear analysis, after processing at least one work process, in one embodiment after processing multiple process cycles, of the robot, during which the load variable values were determined.

This is based on the idea of documenting, during operation, whether, when and/or for how long and/or how often which components or joints have been operated (how) close to their load limits in each case, or have exceeded them if necessary. This can be used advantageously in particular for predictive maintenance, to clarify damage to the robot, and/or to plan future work processes.

In one embodiment, an action of the robot, which is also referred to as a first action without restriction of generality and in particular can comprise one of the actions described here, in particular a speed reduction, evasive movement or the like and/or another action, is carried out when a component of the load values, which is also referred to as a first component without restriction of generality, lies in a predetermined range, which is also referred to as a first range without restriction of generality, in one embodiment an action to reduce this (first) component of the load values.

In a development of this embodiment, another action of the robot, which is also referred to as a second action without restriction of generality and in particular can comprise, in particular be, one (other) of the actions described here, in particular a speed reduction, evasive movement or the like and/or another action, is carried out when the one, or first, component is in another predetermined range, which is also referred to as a second range without restriction of generality, in one embodiment another action for reducing the one, or first, component of the load values.

In one embodiment, this can advantageously reduce a disturbance of or interference with the working operation of the robot.

Additionally or alternatively, in a development of the above embodiment an action of the robot is carried out if another component of the load values, which without restriction of generality is also referred to as a second component, is in a predetermined range, in one embodiment in the one, or first, predetermined range or in another predetermined range. This action can in particular comprise, in particular be, one of the actions described here, in particular a speed reduction, an evasive movement or the like, and/or another action. It can be an action to reduce this other, or second, component. In one embodiment it is the one, or first, action, in another embodiment it is another action or an action different from the one, or first, action, which, without loss of generality, is also referred to as a second action.

This allows different load scenarios to be handled particularly advantageously.

In one embodiment, the one, or first, action and/or the other, or second, action is predetermined by the application program to which the load situation of the robot is signaled and which, in response thereto, causes the robot to perform a, or this, application-program-specific action, wherein in one embodiment the action is selected from multiple predetermined actions on the basis of a user input.

This allows the robot to react particularly appropriately to load situations depending on the application (program), or the user can specify particularly appropriate reactions in each case of the robot to signaled load situations by corresponding input or configuration of the application program or of the action(s) by or in the application program, so that a particularly advantageous operation of the robot can be realized in each case. As a result, the robot reacts specifically to different loads or load situations and can thus avoid or reduce overloading in a more targeted manner. In particular, the robot can react in different applications, or when processing different application programs, in a way that is specific to both the application (program) and the load value component, and thus in one embodiment can avoid or reduce overloading particularly well, wherein, as explained elsewhere, overloading can also be accepted on an application-program-specific basis.

In the above embodiment, in a development the one, or first, and the other, or second, components can both be components of the load value for the same joint. For example, the robot can react differently to either avoid or reduce overloading by a torque or by a rotational speed of the joint, depending on which component of the corresponding load variable value is closer to a permissible maximum value.

In another development of the above embodiment, the one, or first, and the other, or second, components can also be components of load values for different joints. For example, the robot may react differently to either avoid or reduce an overload caused by a torque of one joint or an overload caused by a torque or rotational speed of another joint, depending on which component of the corresponding load variable value is closer to a permissible maximum value.

In one embodiment, the load value for a joint has (in each case) one or more current, or instantaneous, components. This is particularly advantageous in order to reduce load values during operation of the robot through an action of the robot that is determined or predetermined based on these current components, in particular to avoid momentary overloads due to peak loads.

Additionally or alternatively, in one embodiment the load value for a joint has (in each case) one or more singly or multiply time-integrated components. This is particularly advantageous in order to carry out an analysis and/or to signal a load situation of the robot after processing at least one work process, in one embodiment after processing multiple process cycles, since this allows a cumulative load on the robot to be advantageously taken into account.

Similarly, an action of the robot that is determined or predetermined based on such time-integrated components can however also reduce load values during operation of the robot, or current components can also be signaled, for example so that a user or application program can intervene already during operation, or can be saved, for example so that maximum values can be used for analysis.

In one embodiment a time-integrated component is determined for a predetermined time interval, in one embodiment starting from a predetermined point in time, for example a commissioning, maintenance, or the like, and/or for a predetermined period of time, in one embodiment a predetermined period of time up to a current or instantaneous point in time, for example for the last 1, 5, or 10 seconds or the like. Additionally or alternatively, in one embodiment, during a time integration to form a time-integrated component, only current load variable values or load variable value components are taken into account which comprise at least a predetermined minimum magnitude, which in one embodiment is predetermined based on the corresponding limit value or the corresponding limit value component. In one embodiment, this makes it possible to take cumulative loads into account particularly well; in particular, in addition to or as an alternative to an acute overload caused by a momentary peak load, a cumulative overload caused by a corresponding load collective can be taken into account.

In one embodiment, a speed of the robot that is predetermined, in particular in a work program, is reduced, in particular when traveling along a path already predetermined before the current load variable values are determined or by the work program, in order to reduce at least one component of the load values. In one embodiment, this predetermined speed is a path speed or speed of a reference that is fixed relative to the robot, in particular of an end effector and/or TCP.

By performing a speed reduction or action in this way, in one embodiment a load on the robot or a corresponding component of the load values can be reduced in a simple and/or safe manner.

In a development, the robot continues to follow the predetermined path (“path-true”) during this speed reduction, preferably with its reference fixed relative to the robot. Additionally or alternatively, the robot stops (if necessary) during this speed reduction.

As a result, in one embodiment the predetermined path can then continue to be traveled. Additionally or alternatively, in one embodiment this can be used to realize particularly safe behavior of the robot.

In one embodiment, the robot, in addition to or as an alternative to a speed reduction, in a development after the aforementioned speed reduction, carries out an evasive movement dependent on the load values in order to reduce at least one component of the load values. In a development, during this evasive movement the robot, preferably with its reference fixed relative to the robot, deviates from a path, in one embodiment the path, predetermined before the determining of the current load variable values or by the work program.

By means of such an evasive movement, in one embodiment it is possible to react particularly advantageously to an (impending) overloading, or to avoid or reduce it.

In this case, the speed reduction and evasive movement can be combined with one another particularly advantageously by first braking the robot, preferably in a path-true manner, if necessary to a standstill. (Only) if this is not sufficient to reduce the load values sufficiently, the robot performs an evasive movement in which, in one embodiment, it deviates from the path.

In this way, in one embodiment reaction takes place in a cascading or successive manner in order to sufficiently reduce the load (values).

In one embodiment, the evasive movement comprises, and can in particular be, a movement of the robot antiparallel to a projection, in particular transformation, of load values to be reduced into a Cartesian working space of the robot. As explained, the (components of the) load values correspond to loads at the joint level and can thus be transformed from the joint space into the Cartesian working space of the robot in a manner analogous to a known forward transformation. The corresponding projection, in particular transformation, of load value (components) to be reduced by an action, in particular evasive movement, of the robot, or of load value (components) for the reduction of which the action or evasive movement is carried out, into a Cartesian working space of the robot thus points in the generalized direction of the Cartesian working space in which the load (values) would increase the most, so that an antiparallel evasive movement, conversely, reduces these load (values) particularly advantageously. In one embodiment, the Cartesian working space of the robot within the meaning of the present invention comprises the in particular one-, two- or three-dimensional space of a position of a, or the, reference fixed relative to the robot, in particular of an end effector or TCP of the robot, and/or the in particular one-, two- or three-dimensional space of an orientation of the reference fixed relative to the robot, wherein Denavit-Hartenberg descriptions, quaternion descriptions and the like can of course also be understood as the Cartesian working space of the robot within the meaning of the present invention.

In one embodiment, during the evasive movement a reference fixed relative to the robot, preferably an end effector or TCP, of the robot is further held in a position predetermined by a path, in one embodiment the or one of the aforementioned predetermined path(s), in one embodiment a path predetermined before the determining of the current load variable values or by the work program, wherein in a development an orientation of the reference fixed relative to the robot predetermined by this path is abandoned during the evasive movement. Thus, in one embodiment, the reference fixed relative to the robot is held at the predetermined location during the evasive movement, but is rotated in order to avoid an overload situation. As a result, a work process is less disrupted in one embodiment.

In one embodiment, during the evasive movement, a reference fixed relative to the robot, preferably an end effector or TCP, of the robot is further held in an orientation predetermined by a path, in one embodiment the or one of the aforementioned predetermined path(s), in one embodiment a path predetermined before the determining of the current load variable values or by the work program, wherein in a development a position of the reference fixed relative to the robot predetermined by this path is abandoned during the evasive movement. Thus, in one embodiment, the reference fixed relative to the robot is kept in the predetermined orientation during the evasive movement, but is shifted in order to avoid an overload situation. In this way, the direction of impact of a robot end effector or tool can advantageously be maintained, and thus a work process can advantageously be continued.

Both embodiments are combined with one another in a development by, in one embodiment, exploiting a kinematic redundancy of the robot and, during the evasive movement, continuing to hold a reference fixed relative to the robot, preferably an end effector or TCP, of the robot in a position and orientation predetermined by a path, in one embodiment the or one of the aforementioned predetermined path(s), in one embodiment a path predetermined before the determining of the current load variable values or by the work program. For this purpose, in a development in this way a work process can advantageously be continued in one embodiment.

Thus, the following embodiments in particular are claimed as particularly preferred:
a) when traveling along a path predetermined before determining the current load variable values, a predetermined speed of the robot (for the travel) is reduced in order to reduce at least one component of the load values, in one embodiment is reduced in such a way that the robot continues to follow the predetermined path and/or stops when this speed reduction takes place;
b) in one embodiment, after this speed reduction or also according to an independent aspect, the robot carries out an evasive movement dependent on the load values in order to reduce at least one component of the load values. In a development, the robot here carries out an evasive movement antiparallel to a projection of load values to be reduced into a Cartesian working space of the robot;
b1) during the evasive movement, a reference fixed relative to the robot of the robot continues to be held in a position which is predetermined by a path which was predetermined before the current load variable values were determined, wherein an orientation, predetermined by this path, of the reference fixed relative to the robot is abandoned; or
b2) during the evasive movement, a reference fixed relative to the robot of the robot is held in an orientation that is predetermined by a path that was predetermined before the current load variable values were determined, wherein a position, predetermined by this path, of the reference fixed relative to the robot is abandoned; or
b3) during the evasive movement, by exploiting a kinematic redundancy of the robot, a reference fixed relative to the robot of the robot is held in a position and orientation that is predetermined by the path that was predetermined before the determination of the current load variable values.

In one embodiment, preferably after carrying out the aforementioned aspect a) and/or b), in particular b1), b2) or b3), an emergency stop of the robot is carried out, in which, in one embodiment, brakes of the robot are closed. This allows an advantageous end state to be realized in one embodiment.

According to one embodiment of the present invention, a system for operating the robot, in particular realized in hardware and/or software, and in particular in programming in one embodiment, is configured to carry out a method described herein, and/or comprises:
means for determining, for two or more joints, in particular for all joints, a current one-dimensional or multi-dimensional load variable value for the corresponding joint during a movement of the robot caused by joint drives based on at least one sensor value; and
means for determining, for these two or more joints, in particular for all joints, a one-dimensional or multi-dimensional load value for the corresponding joint during the movement of the robot caused by joint drives based on this current load variable value and on a predetermined one-dimensional or multi-dimensional limit value for the joint; and
a) means for causing the robot to perform an action based on the load values to reduce one or more components of those load values, and/or
b) means to signal and/or store a load situation of the robot based on the load values.

In one embodiment, the system or its means comprises:
means for reducing a predetermined speed of the robot, in particular when traveling along a path predetermined before the determining of the current load variable values, in order to reduce at least one component of the load values, in particular such that when the speed is reduced the robot continues to follow the predetermined path and/or stops; and/or
means for carrying out, in particular after the speed reduction, an evasive movement by or with the robot that is dependent on the load values in order to reduce at least one component of the load values, in particular such that the robot deviates from a path predetermined before the current load variable values were determined during the evasive movement and/or such that the evasive movement comprises a movement of the robot antiparallel to a projection of load values to be reduced into a Cartesian working space of the robot, and/or such that during the evasive movement a robot-fixed reference of the robot continues to be held in a position and/or orientation predetermined by a predetermined path; and/or
means for signaling the load situation of the robot to an application program, which in response thereto causes the robot to carry out an application-program-specific action, in particular an action in which load values temporarily exceed predetermined limit values; and/or
means for analysis, based on the stored load situation, of the robot after processing at least one work process, in particular multiple process cycles, of the robot and/or
means for carrying out an action by the robot when a component of the load values is in a predetermined range, in particular an action to reduce this component of the load values, and for carrying out another action of the robot when the one component is in another predetermined range, in particular another action to reduce the one component of the load values; and/or for carrying out an action of the robot when another component of the load values is in a predetermined range, in particular the one predetermined range or another predetermined range, in particular an action to reduce the other component and/or other action.

A system and/or a means in the sense of the present invention may be designed in hardware and/or in software, and in particular may comprise at least one, in particular digital, processing unit, in particular microprocessor unit (CPU), graphic card (GPU) or the like, which is preferably data-connected or signal-connected to a memory system and/or bus system, and/or one or multiple programs or program modules. The processing unit may be designed to process commands that are implemented as a program stored in a memory system, to detect input signals from a data bus and/or to issue output signals to a data bus. A memory system may comprise one or more, in particular different, storage media, in particular optical, magnetic, solid-state, and/or other non-volatile media. The program may be designed in such a way that it embodies or is capable of carrying out the methods described herein, so that the processing unit is able to carry out the steps of such methods and thus, in particular, is able to operate the robot. In one embodiment, a computer program product may comprise, in particular be, an, in particular computer-readable and/or non-volatile, storage medium for storing a program or instructions or with a program stored thereon or with instructions stored thereon. In one embodiment, execution of said program or said instructions by a system or controller, in particular a computer or an arrangement of multiple computers, causes the system or controller, in particular the computer(s), to carry out a method described herein or one or more steps thereof, or the program or instructions are configured to do so.

In one embodiment, one or more, in particular all, steps of the method are implemented completely or partially automatically, in particular by the system or its means.

In one embodiment, the system comprises the robot and/or the application program.

The present invention is particularly suitable for an operation of the robot in which it cooperates with at least one human during the movement caused by joint drives, since unforeseen loads can often occur in this case, for example because a human exerts unexpected forces on the robot.

### BRIEF DESCRIPTION OF THE DRAWINGS

The accompanying drawings, which are incorporated in and constitute a part of this specification, illustrate exemplary embodiments of the invention and, together with a general description of the invention given above, and the detailed description given below, serve to explain the principles of the invention.

FIG. 1 shows a system for operating a robot according to one embodiment of the present invention; and

FIG. 2 shows a method for operating the robot according to one embodiment of the present invention.

### DETAILED DESCRIPTION

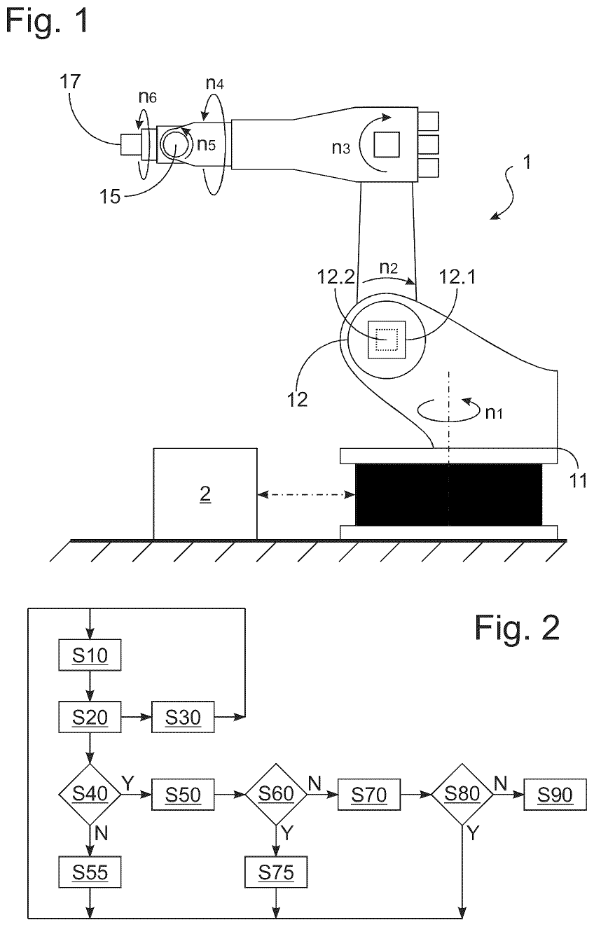

FIG. 1 shows an exemplary system for operating a robot 1 having multiple joints, of which a carousel joint 11, a wrist joint 15 and a swing joint 12, as well as a swing joint drive 12.1 and a sensor arrangement 12.2 with torque sensor and rotational speed sensor, are identified by reference signs. n₁, . . . , n₆ indicate the rotational speeds of the joints or drives, reference sign 2 indicates a controller, and reference sign 17 indicates an end effector of the robot.

FIG. 2 illustrates a method carried out by the controller 2 or the system for operating the robot 1 according to one embodiment of the present invention.

In a step S10, while the robot 1 travels along a predetermined path, a current one-dimensional or multi-dimensional load variable value is determined for each of the joints based on sensor values obtained from sensor arrangements, of which one sensor arrangement 12.2 is indicated as an example in FIG. 1. For example, for each of the joints i=1, . . . , 7 a current torque Tᵢ, a current rotational speed Nᵢ and a current power Pᵢ is determined as a three-dimensional load variable value [Tᵢ, Nᵢ, Pᵢ].

In a step S20, based on these load variable values and a predetermined three-dimensional limit value [TMᵢ, NMᵢ, PMᵢ] for each joint i a three-dimensional load value [BTᵢ, BNᵢ, BPᵢ] is determined for the joint i. This can in particular be the difference between the current values and limit values. Additionally or alternatively, time integrals can also be used.

In a step S30, based on these load values a load situation of the robot is signaled and/or stored before the method or the controller 2 returns to step S10. An application program can react to this signal in a specific way. Additionally or alternatively, a case of damage can then be analyzed based on the stored load values.

Alternatively or additionally or in parallel, an action of the robot is carried out based on the load values to reduce one or more components of these load values.

For this purpose, in step S40 a check is carried out to determine whether one of the load values is within a predetermined range; for example one of the components, normed to 1, of [BTᵢ, BNᵢ, BPᵢ] is at least 0.9, i.e., at least 90% of a permissible load, for example a permissible torque for this joint, a permissible rotational speed for this joint, or a permissible power level for this joint, is achieved for the joint. If this is not the case (S40: “N”), the method or the controller 2 returns to step S10.

Otherwise (S40: “Y”), in a step S50 the speed predetermined for traveling along the path is reduced in path-true fashion, if necessary until the robot stops on the predetermined path.

If this is sufficient for none of the load values to fulfill the criterion any longer (S60: “Y”), the method or the controller 2 returns to step S10.

Otherwise (S60: “N”), in a step S70 the robot 1 carries out an evasive movement.

If this is sufficient for none of the load values to fulfill the criterion any longer (S80: “Y”), the method or the controller 2 likewise returns to step S10. Otherwise (S80: “N”), in step S90 an emergency stop of the robot is carried out.

When returning to step S10, the reduced speed is increased again to the predetermined speed if necessary (step S55) and/or the vehicle is returned to the predetermined path by reversing the evasive movement (step S75).

It can be seen that acute overloading of individual components at the axle or joint level can be advantageously avoided here, which can arise for example if the robot is pulled while traveling the path, thereby unexpectedly exceeding permissible torques or rotational speeds in individual joints.

For a more compact representation, steps S30 and S40-S90 are shown together in FIG. 2, although step S30 or one or more of steps S40-S90 can of course also be omitted. Likewise, the application program can implement one or more of steps S40-S90 in step S30.

Aspects of the present invention are explained below, without being limited to the embodiment of FIG. 1, 2 described above, in particular its details:

Using stored diagrams provided by the manufacturer of the load capacity of the loaded robot components, in each of multiple calculation cycles a comparison is carried out between joint-specific load limits and the current state of the robot. This makes it possible to determine the current load situation continuously and in real time and to implement signals that can be used to react to unwanted overload situations before the robot switches itself off.

Examples of components of a robot whose load limits can be used to specify the limit values include in particular motors, transmissions, brakes, torque sensors, bearings, and structural components or joint bodies.

The monitoring of the load situation can generate warnings or signals to a user program in such a way that the overload situation can be prevented, or in such a way that the overload situation is deliberately entered into, deliberately shortening the service life of the robot.

Additionally or alternatively, entries can be made in a log file in which the overload is recorded for later viewing.

With the help of knowledge of the load situation, it is advantageously possible to push the robot to its mechanical limits, which cannot be predetermined in a generally understandable way in the written documentation of the robot.

The axle- or joint-specific configuration or storage of the limit values or nominal “maximum ratings” can be made in vector form, as can the processing of the load variable values or load value.

Advantageously, unexpected load situations can be taken into account, such as those that can occur particularly in human-robot collaboration/cooperation applications, for example when a human pulls on the robot while it is executing a predetermined path movement.

The load values can in particular comprise the following components:
a) acute or momentary loads. This acute situation is signaled to the application in a prioritized manner and/or is digitally documented in a preferably persistent data file;
b) integral load: even if the robot is operated for a longer period of time just below its load limit, its service life decreases. Therefore, in one embodiment, the invention also offers an indication of the components that are subject to the greatest wear during continuous operation, preferably without triggering an acute situation. For this purpose, load integrals are formed for all joints and are made available to the user for evaluation. In particular, this can be implemented as follows: for each joint, a percentage limit is defined and stored in relation to a stored static upper limit starting from which the joint is to be observed, for example 90% of the maximum permissible load. From this limit onwards, the current load contributes to the formation of an integral. The contribution can also be nonlinear, for example as follows: let M be a current torque of a joint, and Mx the limit value stored for this. Then, in one embodiment, a time integral is formed using the term
   (|M|−80%*Mx)², which however only contributes to the integral if the absolute value of M is also greater than the 90%. Thus, B=∫[(|M|−0.9·Mx)²·(|M|>Mx·0.9?)] dt. This integral becomes larger as operation continues, and is a measure of the accumulated wear. If B is normed with t by calculating B/t, i.e., dividing the load integral by the detection time, a stress factor S is obtained for this component, with which the user can work particularly advantageously. In one embodiment, both variables (B and S) are provided within the controller per joint for the application developer. This gives the user a quantitative expression for the mechanical stress to which he subjects his robot. B and S are preferably each vectors over the quantities to be considered. If a B(t−x) from the past is subtracted from the current B(t) (which was present x seconds ago), a picture of the load situation in the period t−x to t is obtained. This is an advantageous way of masking out load periods that have long since passed, and (B(t)−B(t−x))/x provides an advantageous measure of the robot's load situation in the last x seconds. With these tools, it can easily be determined at which points in a program sequence the movements could perhaps be “softened” in order to extend the service life of the robot.

In one embodiment, acute overload situations are signaled via a call-back call of a function that the user or programmer can define in order to achieve their own behavior or interrupt immediately upon detection in the application. The application can then react to this quickly and individually.

An advantageous aspect is the provision of the load situation in the form of a data structure that can be read by the user program: all current vectors with the percentages of the current loads per axle or joint. From these vectors it is possible to directly determine which values are critical at the axle or joint level, for example torque, speed, or power. From these axle or joint values, vectors can also be forward-transformed into Cartesian space, with which the user or programmer of the application can easily recognize which countermeasures should ideally be taken in the event of an impending load situation in order to avoid the overload situation in a Cartesian manner. Here the load variable vector points in the Cartesian direction in which the load would increase the most. For example, the Cartesian forward-transformed vector for the load situation of the torques points in the direction in which the current axle or joint load would become even greater. Its magnitude can be calculated in particular as a percentage of the maximum load. If the robot's end effector were then pulled in this direction, the load would increase further. Conversely, the situation can be eased by pushing the end effector in the opposite direction. Using vectors of this type, the application developer can design the application in such a way that the robot independently avoids overload situations in permissible situations. The vector with the speed percentage utilization values points, in Cartesian fashion, in the direction in which the robot would have to move further and faster so that the most heavily loaded axes or joints run even further towards the limit. A deceleration in the opposite direction, on the other hand, would optimally ease the situation. Here, too, the application developers are provided with a good means of keeping the robot away from overload situations. The load situations discussed here can occur unexpectedly, in particular due to externally applied forces, for example when a person unexpectedly pulls on the robot, or the like. The load vectors then indicate exactly at the axle or joint level which axle or joint is how far away from the nominal limit, and the Cartesian transformation of the vectors indicates in which direction the force is assumed to act in relation to the end effector or TCP, or that load relief occurs in the opposite direction. The application developer can thus modify the path course online in order to protect the robot.

If an impending overload situation is detected, preferably at least one of the following countermeasures is carried out:

a) Emergency stop: the robot interrupts its work and switches to emergency stop, with braking.

b) Path-true overload prevention: the controller is configured by programming to automatically reduce the speed, and tries to prevent the overload situation without leaving the programmed path. If the overload cannot be avoided in this way, the robot will eventually come to a standstill without however initiating an emergency stop. If the situation is resolved (for example through support from external human interaction or mechanical relief, or program-controlled actions), the robot continues its work while complying with the limit values. It can also reach the target speed again. Preferably, the speed is used here as a control variable in order to avoid an overload situation. If the overload situation is not resolved despite the standstill, a further response can be made without having to trigger an emergency stop. Only if all configured measures are unsuccessful will the robot be put into emergency stop by the subordinate safety system.

c) Overload avoidance by direct evasion: the controller is configured by programming so that it automatically evades the load and tries in this way to avoid the overload situation. The robot then independently deviates in the direction opposite to the load, which direction is given by the vectors calculated above. This mode can also be used when at a standstill, and can be combined with mode b), “path-true overload avoidance.” The robot then tries to stay on the path for as long as possible and, if necessary, to come to a standstill, and, if this does not remedy the situation, to avoid the load. After path-true braking until standstill, the robot finally yields in the exact direction of the load. It thus swerves at the last moment to avoid being overloaded.

d) Path-true evasion in defined redundancies: the control is configured by programming so that it automatically avoids the load and tries in this way to avoid the overload situation.

e) User-specific behavior: the controller can be configured by programing to signal to the user program that the robot is (potentially) overloaded, and the application can implement an action strategy itself. This method offers maximum flexibility, wherein short overload situations are deliberately accepted if necessary, even if the robot has to be repaired more quickly. This can nonetheless be the most economical solution. This can be particularly advantageous in rehabilitation, if for example the robot is guiding a patient's limb and the patient suffers from spasticity during therapy and pulls strongly on the robot. Then, in one embodiment, the robot would simply follow the patient without being damaged and without creating an emergency situation. The user program can perform an evasive movement here without overloading the patient because the application-specific implementation of the evasive strategy is precisely tailored to this setting, and therefore is familiar with the case.

f) The control system records overload situations in an internal log file that the manufacturer can read. The above case c. can therefore also be recognized or proven by the manufacturer and the manufacturer can avoid unjustified repair claims or the like.

Although exemplary embodiments have been explained in the preceding description, it is pointed out that a large number of modifications is possible. It is also pointed out that the exemplary embodiments are merely examples that are not intended to restrict the scope of protection, the applications, and the structure in any way. Rather, the preceding description provides a person skilled in the art with guidelines for implementing at least one exemplary embodiment, with various changes, in particular with regard to the function and arrangement of the described components, being able to be made without departing from the scope of protection as it arises from the claims and from these equivalent combinations of features.

While the present invention has been illustrated by a description of various embodiments, and while these embodiments have been described in considerable detail, it is not intended to restrict or in any way limit the scope of the appended claims to such de-tail. The various features shown and described herein may be used alone or in any combination. Additional advantages and modifications will readily appear to those skilled in the art. The invention in its broader aspects is therefore not limited to the specific details, representative apparatus and method, and illustrative example shown and described. Accordingly, departures may be made from such details without departing from the spirit and scope of the general inventive concept.

### LIST OF REFERENCE SIGNS

1 Robot
2 Controller
11, 12, 15 Joint
12.1 Joint drive
12.2 Sensor arrangement
17 End effector
n₁, . . . , n₆ Rotational speed

What is claimed is:

1. A method for operating a robot (1) that comprises multiple joints (11, 12, 15), wherein during a movement of the robot caused by joint drives (12.1), for two or more, in particular all, joints:
a current one-dimensional or multi-dimensional load variable value is determined for the corresponding joint (S10); and
based on this current load variable value and a one-dimensional or multi-dimensional predetermined limit value for the joint, a one-dimensional or multi-dimensional load value is determined for the joint (S20);
wherein, based on the load values, an action of the robot is carried out to reduce one or more components of these load values and/or, based on the load values, a load situation of the robot is signaled and/or stored.

2-14. (canceled)

15. The method according to claim 1, characterized in that a predetermined speed of the robot, in particular when traveling along a track predetermined before determining the current load variable values, is reduced in order to reduce at least one component of the load values.

16. The method according to claim 15, characterized in that when the speed is reduced, the robot continues to follow the predetermined track and/or stops.

17. The method according to claim 1, characterized in that the robot, in particular after the speed reduction, carries out an evasive movement dependent on the load values in order to reduce at least one component of the load values, in particular deviates from a track predetermined before the determination of the current load variable values.

18. The method according to claim 17, characterized in that the evasive movement comprises a movement of the robot antiparallel to a projection of load values to be reduced into a Cartesian working space of the robot.

19. The method according to claim 17, characterized in that during the evasive movement a reference, fixed relative to the robot, of the robot continues to be held in a position and/or orientation predetermined by a track predetermined before the determination of the current load variable values.

20. The method according to claim 1, characterized in that the load situation of the robot is signaled to an application program, which in response thereto causes the robot to carry out an application-program-specific action.

21. The method according to claim 1, characterized in that when a component of the load values is in a predetermined range, an action of the robot is carried out, in particular an action to reduce this component of the load values, and that
when the one component is in another predetermined range, another action of the robot is carried out, in particular another action to reduce the one component of the load values; and/or
when another component of the load values is in a predetermined range, in particular the one predetermined range or another predetermined range, an action of the robot is carried out, in particular an action to reduce the other component and/or other action.

22. The method according to claim 20, characterized in that at least one of the actions is predetermined by the application program, in particular is selected from multiple predetermined actions on the basis of a user input.

23. The method according to claim 1, characterized in that the stored load situation of the robot is used for an analysis after processing at least one work process, in particular multiple process cycles, of the robot.

24. The method according to claim 1, characterized in that the load variable value and/or load value for a joint depends on a torque and/or a speed at the joint and/or comprises at least one current and/or at least one time-integrated component.

25. The method according to claim 1, characterized in that the robot cooperates with at least one human during the movement caused by joint drives.

26. A system for operating a robot (1) that comprises multiple joints (11, 12, 15), wherein the system is set up to carry out a method according to claim 1 and/or comprises:
means for determining, for two or more joints, in particular for all joints, a current one-dimensional or multi-dimensional load variable value for the corresponding joint during a movement of the robot caused by joint drives based on at least one sensor value; and
means for determining, for these two or more joints, in particular for all joints, a one-dimensional or multi-dimensional load value for the corresponding joint during the movement of the robot caused by joint drives based on this current load variable value and on a one-dimensional or multi-dimensional predetermined limit value for the joint; and
means for causing the robot to carry out, based on the load values, an action to reduce one or more components of these load values, and/or means for signaling and/or storing a load situation of the robot based on the load values.

27. A computer program or computer program product, wherein the computer program or computer program product includes instructions, in particular stored on a computer-readable and/or non-volatile storage medium, which, when executed by one or more computers or a system, cause the computer(s) or system to carry out a method according to claim 1.
